(19) United States
(12) Patent Application Publication
(10) Pub. No.: US 2025/0371036 A1
(43) Pub. Date: Dec. 4, 2025

(54) AUTOMATIC TAG PROPAGATION

(71) Applicant: Snowflake Inc., Bozeman, MT (US)

(72) Inventors: Ankit Gupta, Sammamish, WA (US); Yimeng Li, Bellevue, WA (US); Yujie Li, Santa Clara, CA (US); David Schultz, Piedmont, CA (US); Chao Tan, Issaquah, WA (US); Yunqiao Zhang, Bellevue, WA (US); Zhiyuan Zhou, Bellevue, WA (US)

(21) Appl. No.: 18/797,241

(22) Filed: Aug. 7, 2024

Related U.S. Application Data
(60) Provisional application No. 63/654,576, filed on May 31, 2024.

(51) Int. Cl. G06F 16/28; G06F 16/242

(52) U.S. Cl. CPC G06F 16/285; G06F 16/242

(57) ABSTRACT

A tag propagator may obtain a SQL statement. As a result of obtaining the SQL statement, object dependencies between objects referenced in the SQL statement may be determined. Tags associated with the determined object dependencies may be further determined. The tags may be propagated.

### CROSS REFERENCE TO RELATED APPLICATIONS

This application claims the benefit of U.S. Provisional Application No. 63/654,576, entitled “Automatic Tag Propagation,” filed May 31, 2024, the disclosure of which is incorporated herein by reference in its entirety.

### TECHNICAL FIELD

The present disclosure relates to data sharing platforms, and particularly to providing, automatically or on-demand, automatic tag propagation within a data sharing platform.

### BACKGROUND

Databases are widely used for data storage and access in computing applications. A goal of database storage is to provide enormous sums of information in an organized manner so that it can be accessed, managed, and updated. In a database, data may be organized into rows, columns, and tables. Different database storage systems may be used for storing different types of content, such as bibliographic, full text, numeric, and/or image content. Further, in computing, different database systems may be classified according to the organization approach of the database. There are many different types of databases, including relational databases, distributed databases, cloud databases, object-oriented and others. Elements of databases may be tagged with semantic information. In some cases, propagation of these tags may be valuable for various purposes.

Databases are used by various entities and companies for storing information that may need to be accessed or analyzed. In an example, a retail company may store a listing of all sales transactions in a database. The database may include information about when a transaction occurred, where it occurred, a total cost of the transaction, an identifier and/or description of all items that were purchased in the transaction, and so forth. The same retail company may also store, for example, employee information in that same database that might include employee names, employee contact information, employee work history, employee pay rate, and so forth. Depending on the needs of this retail company, the employee information and the transactional information may be stored in different tables of the same database. The retail company may have a need to “query” its database when it wants to learn information that is stored in the database. This retail company may want to find data about, for example, the names of all employees working at a certain store, all employees working on a certain date, all transactions for a certain product made during a certain time frame, and so forth.

When the retail store wants to query its database to extract certain organized information from the database, a query statement is executed against the database data. The query returns certain data according to one or more query predicates that indicate what information should be returned by the query. The query extracts specific data from the database and formats that data into a readable form. The query may be written in a language that is understood by the database, such as Structured Query Language (“SQL”), so the database systems can determine what data should be located and how it should be returned. The query may request any pertinent information that is stored within the database. If the appropriate data can be found to respond to the query, the database has the potential to reveal complex trends and activities. This power can only be harnessed through the use of a successfully executed query.

Traditional database management requires companies to provision infrastructure and resources to manage the database in a data center. Management of a traditional database can be very costly and requires oversight by multiple persons having a wide range of technical skill sets. Traditional relational database management systems (RDMS) require extensive computing and storage resources and have limited scalability. Large sums of data may be stored across multiple computing devices. A server may manage the data such that it is accessible to customers with on-premises operations. For an entity that wishes to have an in-house database server, the entity must expend significant resources on a capital investment in hardware and infrastructure for the database, along with significant physical space for storing the database infrastructure. Further, the database may be highly susceptible to data loss during a power outage or other disaster situations. Such traditional database systems have significant drawbacks that may be alleviated by a cloud-based database system.

A cloud database system may be deployed and delivered through a cloud platform that allows organizations and end users to store, manage, and retrieve data from the cloud. Some cloud database systems include a traditional database architecture that is implemented through the installation of database software on top of a computing cloud. The database may be accessed through a Web browser or an application programming interface (API) for application and service integration. Some cloud database systems are operated by a vendor that directly manages backend processes of database installation, deployment, and resource assignment tasks on behalf of a client. The client may have multiple end users that access the database by way of a Web browser and/or API. Cloud databases may provide significant benefits to some clients by mitigating the risk of losing database data and allowing the data to be accessed by multiple users across multiple geographic regions.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example shared data processing platform implementing secure messaging between deployments, in accordance with aspects of the present disclosure.

FIG. 2 is a block diagram illustrating components of the compute service manager, in accordance with aspects of the present disclosure.

FIG. 3 is a block diagram depicting an embodiment of an execution platform in accordance with some embodiments of the present disclosure.

FIG. 4 illustrates a cloud deployment, in accordance with some embodiments of the present disclosure.

FIG. 5 is a block diagram illustrating the compute service manager performing automatic tag propagation functions, in accordance with some embodiments of the present disclosure.

FIG. 6 is a block diagram illustrating an example of a data dictionary, in accordance with some embodiments of the present disclosure.

FIG. 7 is a flow diagram illustrating automatic tag propagation, in accordance with some embodiments of the present disclosure.

FIG. 8 is a flow diagram illustrating automatic tag propagation, in accordance with some embodiments of the present disclosure.

FIG. 9 is a flow diagram of a method for providing automatic tag propagation in a data exchange, in accordance with some embodiments of the present disclosure.

FIG. 10 is a block diagram of an example computing device that may perform one or more of the operations described herein, in accordance with some embodiments of the present disclosure.

### DETAILED DESCRIPTION

Tags are a type of attribute that can be applied to data in a database. Tags enable data stewards to monitor sensitive data for compliance, discovery, protection, and resource usage use cases. Often treated as metadata, tags can protect the access to data by association through tag-based policies and can capture semantic meanings of tabular and columnar data.

As data is organized and reorganized within a share, metadata associated with the data should follow the data, or be propagated. Propagating tags, or metadata, can ensure that the data remains discoverable, protected, and organized without requiring rework by the data stewards. Tag propagation can follow an object hierarchy, e.g., from an account, to a database, to a schema within the database, to a table within the database, and to a column within the table. Tag propagation can also follow a data lineage, e.g., a view created from a table (semantic metadata), or a second table created from a first table (semantic metadata and protection (or accessibility) metadata).

Users want to ensure that tags and tag-based policies that are used for access control get applied whenever data is copied to other objects. This ensures that the data remains protected regardless of where it travels.

Users also create tags that describe tabular and columnar data. This can include short descriptions, help text, or links to internal knowledge bases. As data is projected from a table to a view, the view and its columns can obtain the semantic tags from the underlying base tables. This can ensure that a data analyst using the views for analytics and reporting has any semantic information available to them. One mechanism for propagating tags is to copy them manually.

However, manual tag propagation implies that users copying or projecting the data must manually copy tags from the source objects. This shifts the onus on the users to keep track of all the objects getting created in the system. Manual efforts to keep the data discoverable and protected can entail a significant amount of work. This approach not only fails to scale but can be prone to user error that leaves data unprotected and undiscoverable. Automatic tag and tag-based policy propagation addresses a need for the automated discovery and protection of data when it is projected or copied.

A solution to this problem is to allow users to control whether a tag automatically propagates via simple tag level configurations. Such a mechanism can provide for Automatic propagation of the tags and tag-based policies whenever data is copied from one table to another, or when data is projected from a table by a view, and keeping the propagated tags continuously updated on a destination against any changes in the source, for cases having a direct object dependency.

Embodiments of the present disclosure address the above noted and other issues by providing techniques for the use of automatic tag propagation that can ensure persistence of metadata tags in a data exchange.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

Reference throughout this specification to “one embodiment,” “an embodiment,” “one implementation,” “an implementation,” “one example,” or “an example” means that a particular feature, structure, or characteristic described in connection with the embodiment, implementation, or example is included in at least one embodiment of the present disclosure. Thus, appearances of the above-identified phrases in various places throughout this specification are not necessarily all referring to the same embodiment, implementation, or example. In addition, it should be appreciated that the figures provided herewith are for explanation purposes to persons ordinarily skilled in the art.

As used herein, the terms “comprising,” “including,” “containing,” and grammatical equivalents thereof are inclusive or open-ended terms that do not exclude additional, unrecited elements or method steps.

As used herein, “table” is defined as a collection of records (rows). Each record contains a collection of values of table attributes (columns). Tables are typically physically stored in multiple smaller (varying size or fixed size) storage units, e.g. files or blocks.

Embodiments in accordance with the present disclosure may be embodied as an apparatus, method or computer program product. Accordingly, the present disclosure may take the form of an entirely hardware-comprised embodiment, an entirely software-comprised embodiment (including firmware, resident software, micro-code, etc.) or an embodiment combining software and hardware aspects that may generally be referred to herein as a “circuit,” “module” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure May be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein may operate on a flexible and scalable data warehouse using a new data processing platform. In some embodiments, the described systems and methods leverage a cloud infrastructure that supports cloud-based storage resources, computing resources, and the like. Example cloud-based storage resources offer significant storage capacity available on-demand at a low cost. Further, these cloud-based storage resources may be fault-tolerant and highly scalable, which can be costly to achieve in private data storage systems. Example cloud-based computing resources are available on-demand and may be priced based on actual usage levels of the resources. Typically, the cloud infrastructure is dynamically deployed, reconfigured, and decommissioned in a rapid manner.

In the described systems and methods, a data storage system utilizes an SQL (Structured Query Language)-based relational database. However, these systems and methods are applicable to any type of database, and any type of data storage and retrieval platform, using any data storage architecture and using any language to store and retrieve data within the data storage and retrieval platform. The systems and methods described herein further provide a multi-tenant system that supports isolation of computing resources and data between different customers/clients and between different users within the same customer/client.

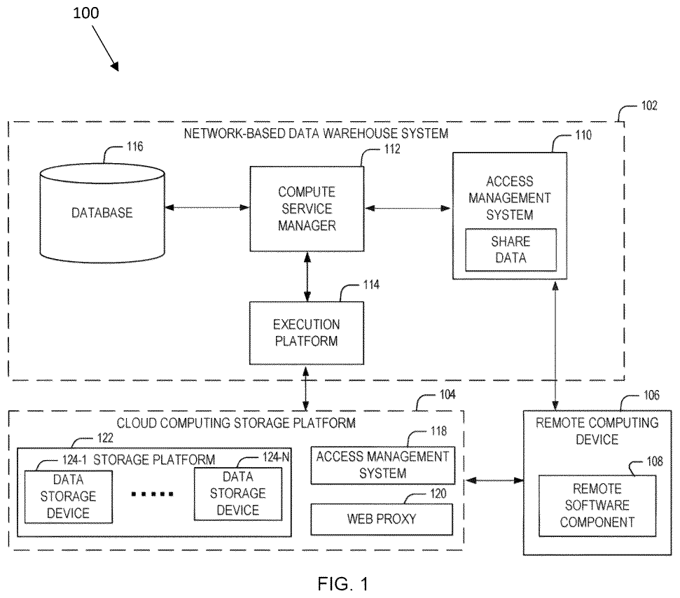

FIG. 1 illustrates an example shared data processing platform implementing secure messaging between deployments. As shown, the shared data processing platform 100 includes the network based data warehouse system 102, a cloud computing storage platform 104 (e.g., a storage platform, an AWS® service, Microsoft Azure®, or Google Cloud Platform®), and a remote computing device 106. The network based data warehouse system 102 is a network based system used for storing and accessing data (e.g., internally storing data, accessing external remotely located data) in an integrated manner, and reporting and analysis of the integrated data from the one or more disparate sources (e.g., the cloud computing storage platform 104).

The cloud computing storage platform 104 includes multiple computing machines and provides on-demand computer system resources, such as data storage and computing power, to the network based data warehouse system 102. While in the example illustrated in FIG. 1, a data warehouse is depicted, other embodiments may include other types of databases or other data processing systems. The cloud computing storage platform 104 provides a variety of storage and data management functionalities, such as data storage, scalability, data redundancy and replication, data security, backup and disaster recovery, data lifecycle management, integration, among others. Row level security and RAPs enable various users with different roles to properly access and use the functionalities within respective authorizations or privileges. As such, the nested RAPs disclosed herein may enhance various functionalities of the cloud computing storage platform 104, as discussed below.

The remote computing device 106 (e.g., a user device such as a laptop computer) includes one or more computing machines (e.g., a user device such as a laptop computer) that execute a remote software component 108 (e.g., browser accessed cloud service) to provide additional functionality to users of the network based data warehouse system 102. The remote software component 108 includes a set of machine-readable instructions that, when executed by the remote computing device 106, cause the remote computing device 106 to provide certain functionalities of the cloud computing storage platform 104 as mentioned above. The remote software component 108 may operate on input data and generates result data based on processing, analyzing, or otherwise transforming the input data. As an example, the remote software component 108 can be a data provider or data consumer that enables database tracking procedures, such as streams on shared tables and views.

The network based data warehouse system 102 includes an access management system 110, a compute service manager 112, an execution platform 114, and a database 116. The access management system 110 enables administrative users to manage access to resources and services provided by the network based data warehouse system 102. Administrative users can create and manage users, roles, and groups, and use permissions to allow or deny access to resources, functionalities, and services at the network based data warehouse system 102. The access management system 110 can store share data that securely manages shared access to the storage resources of the cloud computing storage platform 104 amongst different users of the network based data warehouse system 102, as discussed in further detail below.

The compute service manager 112 coordinates and manages operations of the network based data warehouse system 102. The compute service manager 112 performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to the database 116, which is associated with the entirety of data stored on the shared data processing platform 100. The database 116 stores data pertaining to various functions and aspects associated with the network based data warehouse system 102 and its users. In some embodiments, the database 116 includes a summary of data stored in remote data storage systems as well as data available from one or more local caches. Additionally, the database 116 may include information regarding how data is organized in the remote data storage systems and the local caches. The database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

The execution platform 114 is coupled to multiple data storage devices 124-1 to 124-N that belong to a cloud computing storage platform 104. In some embodiments, the data storage devices 124-1 to 124-N are cloud-based storage devices located in one or more geographic locations. For example, the data storage devices 124-1 to 124-N may be part of a public cloud infrastructure or a private cloud infrastructure. The data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems), object storage systems, and the like.

The execution platform 114 includes a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (QOM) error mitigation process; a third process that extracts health information from process logs and status information to send back to the compute service manager 112; a fourth process to establish communication with the compute service manager 112 after a system boot; and a fifth process to handle the communication with a compute cluster for a given job provided by the compute service manager 112 and to communicate information back to the compute service manager 112 and other compute nodes of the execution platform 114.

The cloud computing storage platform 104 also includes an access management system 118 and a web proxy 120. As with the access management system 110, the access management system 118 allows users to create and manage users, roles, and groups, and use permissions to allow or deny access to cloud services and resources. The access management system 110 of the network based data warehouse system 102 and the access management system 118 of the cloud computing storage platform 104 can communicate and share information so as to enable access and management of resources and services shared by users of both the network based data warehouse system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 1, the data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network based data warehouse system 102 based on the changing data storage/retrieval needs as well as the changing needs of the users and systems accessing the shared data processing platform 100. The support of dynamic changes allows network based data warehouse system 102 to scale quickly in response to changing demands on the systems and components within network based data warehouse system 102. The decoupling of the computing resources from the data storage devices 124-1 to 124-N supports the storage of large amounts of data without requiring a corresponding large amount of computing resources.

Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Though the compute service manager 112, the database 116, the execution platform 114, the cloud computing storage platform 104, and the remote computing device 106 are shown in FIG. 1 as individual components, they may be implemented as a distributed system (e.g., distributed across multiple systems/platforms at multiple geographic locations) connected by APIs and access information (e.g., tokens, login data). Additionally, each of the compute service manager 112, the database 116, the execution platform 114, and the cloud computing storage platform 104 can be scaled up or down (independently of one another) depending on changes to the requests received and the changing needs of shared data processing platform 100. Thus, in the described embodiments, the network based data warehouse system 102 is dynamic and supports regular changes to meet the current data processing needs.

During operation, the network based data warehouse system 102 may process multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task.

The metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, the computing resources and the cache resources may retrieve data from, and store data to, any of the data storage resources in the cloud computing storage platform 104.

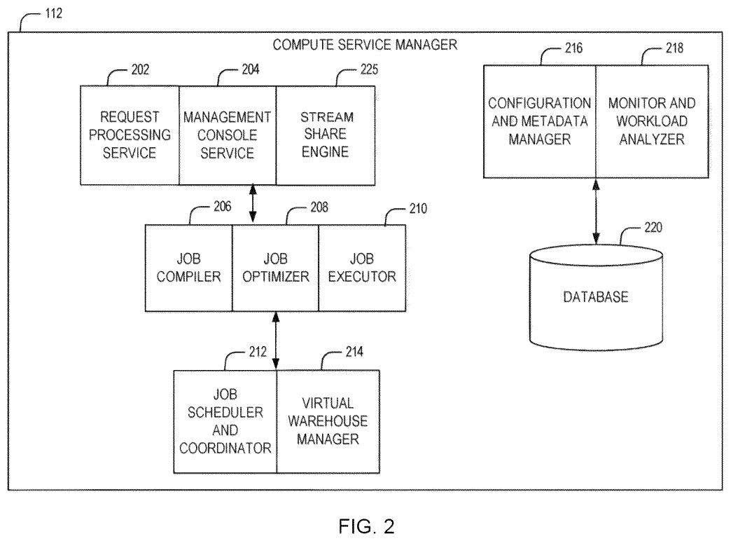

FIG. 2 is a block diagram illustrating components of the compute service manager 112, in accordance with aspects of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104.

A management console service 204 supports access to various systems and processes by administrators and other system managers. Additionally, the management console service 204 may receive a request to execute a job and monitor the workload on the system. The stream share engine 225 manages change tracking on database objects, such as a data share (e.g., shared table) or shared view, according to some example embodiments, and as discussed in further detail below.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks.

A virtual warehouse manager 214 manages the operation of multiple virtual warehouses implemented in the execution platform 114. As discussed below, each virtual warehouse includes multiple execution nodes that each include a cache and a processor (e.g., a virtual machine, or an operating system level container execution environment).

The compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job.

A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network based data warehouse system 102 and may further redistribute tasks based on a user (e.g., “external”) query workload that may also be processed by the execution platform 114.

Additionally, the configuration and metadata manager 216 may manage the information related to the data stored in the remote data storage devices and in the local caches. The monitor and workload analyzer 218 oversees the processes performed by the compute service manager 112 and manages the distribution of tasks (e.g., workload) across the virtual warehouses and execution nodes in the execution platform.

The configuration and metadata manager 216 and the monitor and workload analyzer 218 are coupled to a data storage device 220 (database). The data storage device 220 in FIG. 2 represents any data storage device within the network-based data warehouse system 102. For example, data storage device 220 may represent caches in execution platform 114, storage devices in cloud computing storage platform 104, or any other storage devices.

In some cases, the compute service manager 112 may include other components or functionalities not expressly shown in FIG. 2. For example, the compute service manager 112 may further include an access manager and/or a key manager coupled to the database 220. The access manager may handle authentication and authorization tasks for the systems described herein. The key manager may manage storage and authentication of keys used during authentication and authorization tasks. The request processing service 202 manages, along with the access manager and/or the key manager, received data storage requests and data retrieval requests. The management console service 204 may collaboratively supports access to various systems and processes by administrators and other system managers.

The compute service manager 112 may also include a compute service manager 112 that includes an SQL compiler, an SQL optimizer, and an SQL executor. The SQL compiler parses SQL queries and generates the execution code for the queries. The SQL optimizer determines the best method to execute queries based on the data that needs to be processed. The SQL executor executes the query code for queries received by resource manager. The job scheduler and coordinator 212 may send received queries to the appropriate services or systems for compilation, optimization, and dispatch to the compute service manager 112. The virtual warehouse manager 214 manages the operation (e.g., in view of the received queries or jobs) of multiple virtual warehouses implemented in an execution platform.

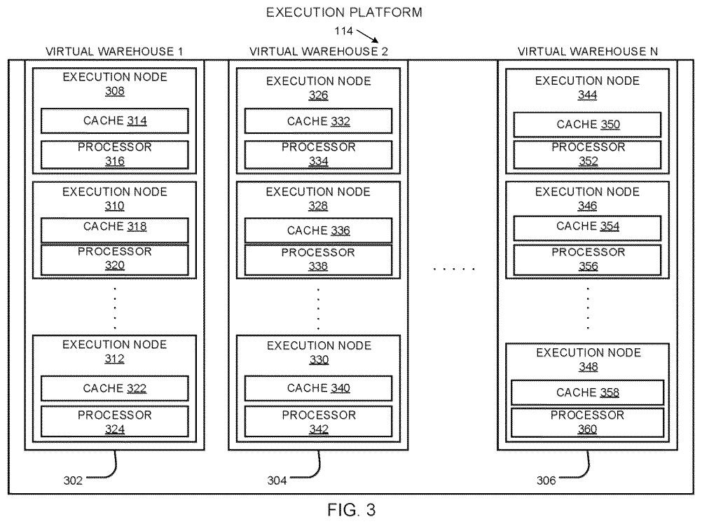

FIG. 3 is a block diagram depicting an embodiment of an execution platform 114. As shown in FIG. 3, the execution platform 114 includes multiple virtual warehouses 302, 304, and 306 (e.g., from 1 to N, where N is a natural number). Each virtual warehouse includes multiple execution nodes that each includes a cache and a processor. Although each virtual warehouse 302, 304, 306 shown in FIG. 3 includes three execution nodes, a particular virtual warehouse may include any number of execution nodes without departing from the scope of the disclosure. Further, the number of execution nodes in a virtual warehouse is dynamic, such that new execution nodes are created when additional demand is present, and existing execution nodes are deleted when they are no longer necessary.

Each virtual warehouse 302, 304, 306 is capable of accessing any of the data storage devices 124-1, . . . , 124-N shown in FIG. 1. Thus, virtual warehouses 302, 304, 306 are not necessarily assigned to a specific data storage device 116, 118, 120 and, instead, can access data from any of the data storage devices 124-1, . . . , 124-N. Similarly, each of the execution nodes shown in FIG. 3 can access data from any of the data storage devices 124-1, . . . , 124-N. In some embodiments, a particular virtual warehouse or a particular execution node may be temporarily assigned to a specific data storage device, but the virtual warehouse or execution node may later access data from any other data storage device.

In the example of FIG. 3, the virtual warehouse 302 includes three execution nodes 308, 310, and 312. The execution node 308 includes a cache 314 and a processor 316. Execution node 310 includes a cache 318 and a processor 320. The execution node 312 includes a cache 322 and a processor 324. Each execution node 308, 310, 312 is associated with processing one or more data storage and/or data retrieval tasks. For example, a particular virtual warehouse may handle data storage and data retrieval tasks associated with a particular user or customer. In other implementations, a particular virtual warehouse may handle data storage and data retrieval tasks associated with a particular data storage system or a particular category of data.

Similar to virtual warehouse 302 discussed above, the virtual warehouse 304 includes three execution nodes 326, 328, and 330. Execution node 326 includes a cache 332 and a processor 334. Execution node 328 includes a cache 336 and a processor 338. Execution node 330 includes a cache 340 and a processor 342. Additionally, virtual warehouse 306 includes three execution nodes 344, 346, and 348. Execution node 344 includes a cache 350 and a processor 352. Execution node 346 includes a cache 354 and a processor 356. Execution node 348 includes a cache 358 and a processor 360.

Although the execution nodes shown in FIG. 3 each include one cache and one processor; alternative embodiments may include execution nodes containing any number of processors and any number of caches. Additionally, the caches may vary in size among the different execution nodes. The caches shown in FIG. 3 store, in the local execution node, data that was retrieved from one or more data storage devices in a storage platform 104 (see FIG. 1). Thus, the caches reduce or eliminate potential bottleneck problems occurring in platforms that consistently retrieve data from remote storage systems. Instead of repeatedly accessing data from the remote storage devices, the systems and methods described herein access data from the caches in the execution nodes which is significantly faster and avoids the bottleneck problem. In some embodiments, the caches are implemented using high-speed memory devices that provide fast access to the cached data. Each cache can store data from any of the storage devices in storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, a particular execution node may be assigned more processing resources if the tasks performed by the execution node become more processor intensive. Similarly, an execution node may be assigned more cache resources if the tasks performed by the execution node require a larger cache capacity.

Although the virtual warehouses 302, 304, 306 are associated with the same execution platform 114 of FIG. 1, the virtual warehouses 302, 304, 306 of FIG. 3 may be implemented using multiple computing systems at multiple geographic locations. For example, the virtual warehouse 302 can be implemented by a computing system at a first geographic location, while the virtual warehouses 304 and 306 are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, a particular instance of the virtual warehouse 302 implements execution nodes 308 and 310 on one computing platform at a particular geographic location and implements execution node 312 at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse. The execution platform 114 is also fault tolerant. For example, if one virtual warehouse fails, that virtual warehouse is quickly replaced with a different virtual warehouse at a different geographic location.

A particular execution platform 114 may include any number of virtual warehouses (in addition to the illustrated virtual warehouses 302, 304, 306). Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

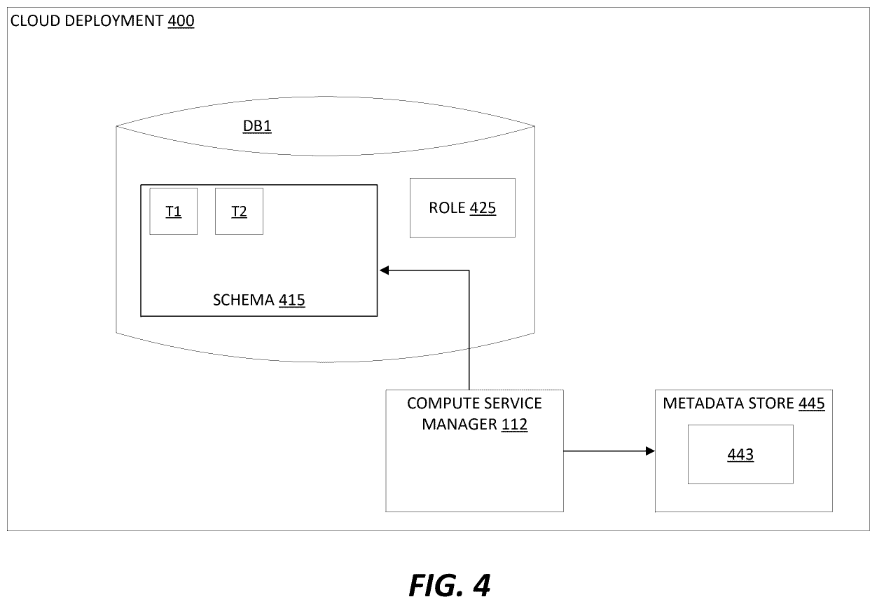

FIG. 4 illustrates a cloud deployment 400, which may have an architecture comprising the compute service manager 112 and the cloud computing storage platform 104 illustrated in FIG. 1. Although illustrated as a single cloud deployment, the cloud environment 400 may be one of multiple cloud deployments that the shared data processing platform is comprised of and which may be physically located in separate remote geographical regions but may all be deployments of a single the shared data processing platform.

Containers such as databases and schemas may be used to organize data stored in the cloud deployment 400 (e.g., in the cloud computing storage platform 104) and each database may belong to a single account within the cloud deployment 400. Each database may be thought of as a container having a classic folder hierarchy within it. Each database may be a logical grouping of schemas and a schema may be a logical grouping of database objects (tables, views, etc.). Each schema may belong to a single database. The example of FIG. 4 includes a database DB1, which includes a schema 415. The schema 415 may in turn include tables T1 and T2. The cloud deployment 400 may utilize any appropriate metadata store 445 such as FoundationDB, for example, to store the grant and other metadata of schema 415 and any other schemas within database DB1.

The metadata store 445 may also include one or more tags 443. The tags 443 may facilitate simpler sharing of data contained in the database DB1. As an example, a large company may have a human resources (HR) listing containing HR data for its internal employees on a data exchange. The HR data may contain ten types of HR data, e.g., employee number, selected health insurance, current retirement plan, or job title. The HR listing may be accessible to 100 people in the company, e.g., everyone in the HR department. Management of the HR department may wish to add an eleventh type of HR data, e.g., an employee stock option plan. Instead of manually adding this to the HR listing and granting each of the 100 people access to this new data, management may simply apply an HR tag to the new data set that can be used to categorize the data as HR data, list it along with the HR listing, and grant access to the 100 people to view the new data set. In some cases, the tags may propagate to objects created from the new data set.

FIG. 4 also illustrates the compute service manager 112, which may function to perform the query processing, object discovery, RBAC, and other functions of the cloud deployment 400. The compute service manager 112 may implement role-based access control (RBAC) to govern access to objects within schema 415 using account level roles and grants (not shown). Account level roles are special objects in a consumer account that are assigned to users, and grants between an account level role and database objects define what privileges the account level role has on these objects. The account level roles of a user include a special role called e.g., “PUBLIC” which every user is granted, and some number of additional user-created roles. For example, a role that has a usage grant on a database can “see” the database when executing the command “show databases,” while a role that has a select grant on a table can read from the table but not write to the table. The role would need to have a modify grant on the table to be able to write to it. These roles exist in a hierarchy where certain roles dominate others. Granting one role to another role creates the role hierarchy and determines which roles dominate which other roles (e.g., a first role dominates a second role that is granted to it). A permission may comprise a privilege which applies to an object, such as SELECT (privilege) on a particular TABLE (object). Permissions are granted to roles and every role inherits all permissions granted directly to itself and those granted to any role that it (recursively) dominates.

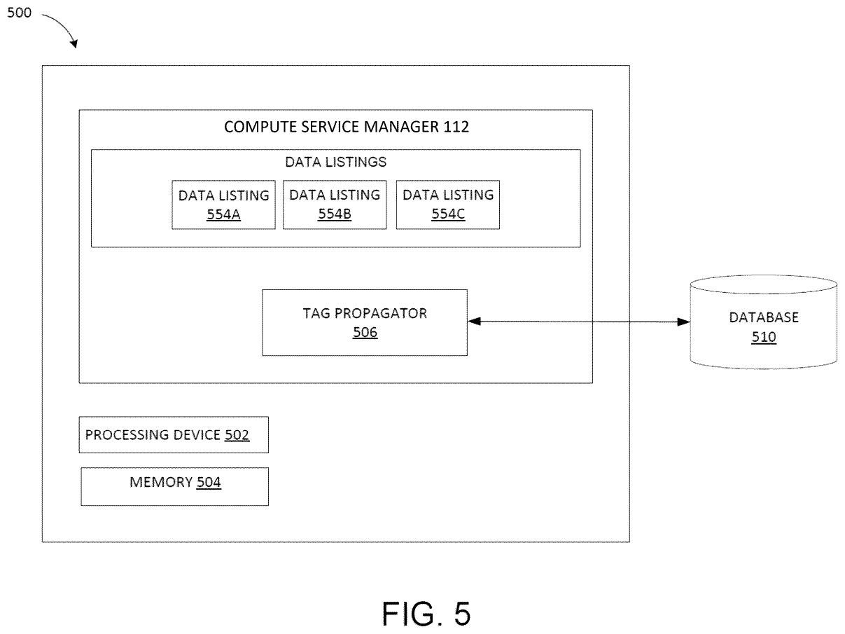

FIG. 5 is a block diagram illustrating the compute service manager 112 of FIGS. 1 and 4, performing automatic tag propagation functions, in accordance with some embodiments of the present disclosure. FIG. 5 illustrates compute service manager 112 executing on computing device 500, which may be part of the deployment 400 (illustrated in FIG. 4).

Automatic tag propagation has at least two advantages over a manual process. First, it simplifies the process, by specifying that a tag needs to propagate, it can be automatically applied to all its associations and their dependencies. Second, it avoids the consequences of users forgetting to manually propagate. Additionally, users may be unaware of or forget to propagate important metadata when creating new derivative entities. A solution includes a declarative means for users to control whether a tag automatically propagates or not via a simple tag level configuration. Tags and tag-based policies can automatically propagate whenever data is copied from one table to another, or when data is projected from a table by a view. Additionally, propagated tags can be continuously updated on a destination with any changes in the source, for those situations in which there is a direct object dependency, e.g., a tag propagated from a table to a view. Such a capability can eliminate potential rework and/or errors resulting from a failure to manually apply tags and corresponding policies when data is copied or projected.

For example, a tag could be automatically propagated with a SQL statement such as:

$$CREATE [ OR REPLACE ] TAG [ IF NOT EXISTS ] < name > [ COMMENT = ' < string\_literal > ' ] [ PROPAGATE = TRUE / FALSE ] ;$$

Automatic tag propagation can be simple to configure and support granular controls with default values. Tags are used for different purposes. A tag oriented towards protection, with a label of “Sensitive data” may require propagation whereas tags associated with cost governance or ownership may not. Users can be able to specify which tags propagate and when.

Computing device 500 may include hardware such as processing device 502, e.g., processors, central processing units (CPUs), memory 504, e.g., random access memory, (RAM), storage devices, e.g., hard-disk drives (HDDs), solid-state drives (SSDs), and other hardware devices, e.g., sound cards or video cards.

Processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as a microcontroller, an application specific integrated circuit (ASIC), a field programmable gate array (FPGA), a digital signal processor (DSP), network processor, or the like.

Memory 504 may include volatile memory devices, e.g., RAM, non-volatile memory devices, e.g., flash memory, and/or other types of memory devices. As a non-limiting example, the non-volatile memory may include a read-only memory (ROM), a programmable read-only memory (PROM), an erasable programmable read-only memory (EPROM), an electrically erasable programmable read-only memory (EEPROM), or a flash memory. In certain implementations, memory 504 may be non-uniform access (NUMA), such that memory access time depends on the memory location relative to processing device 502. In some embodiments, memory 504 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 504 may be configured for long-term storage of data and may retain data between power on/off cycles.

The compute service manager 112 may include a tag propagator 506 to provide logic and an interface for defining tags and tag-related policies. As discussed herein, the data exchange may include a plurality of published data listings 554A-554C. Furthermore, in some embodiments, the tag propagator 506 connects to a database 510.

In some embodiments, tag propagator 506 propagates tags when creating or modifying an object from one or more source objects. If there are tags attached to the source objects, they will be propagated to the new object. For example, creating an object with data flow, e.g. “CREATE TABLE AS SELECT,” creating a referencing object, e.g. “CREATE VIEW,” or modifying a referencing object, e.g. “ALTER POLICY SET BODY <object>,” will result in any associated tags being propagated.

In some embodiments, tag propagator 506 propagates tags from a referenced object to many referencing objects. If there are tags attached to the referenced objects, their changes could be propagated to the downstream referencing objects. This can include changes between a tag and referenced object, e.g., “ALTER <object> SET TAG;” in which a new tag is created on a referenced object that will propagate to any referencing objects, or “ALTER <object> UNSET TAG;” which would remove a tag from an object and any referencing objects. In some embodiments, changes to the object result in tag propagation. For example, “DROP <object>;” and “UNDROP <object>;” result in tags removed (or restored) from referencing objects. In some embodiments, “ALTER VIEW <old> RENAME TO <new>;” or “ALTER TABLE <table> SWAP WITH <new>;” result in tag propagation. In some embodiments, toggling the PROPAGATE property on a tag, e.g., “ALTER <tag> SET PROPAGATE;” can result in tags being propagated to referencing objects. Tag removal and restoration from an object can propagate to referencing objects. For example, “DROP <tag>;” or “UNDROP <tag>;”. In some embodiments, tag propagator 506 performs all tag propagation within database transactional boundaries. In some embodiments, tag propagator 506 supports both tag propagation to new objects, e.g., “CREATE VIEW,” as well as updates to existing objects. In some embodiments, a change to a tag on the referenced object would result in propagation of the change to its referencing objects. In some embodiments, this is termed Continuous Propagation.

In some embodiments, tag propagator 506 determines how to propagate tags based on previously applied tags to a current entity and propagated tags from referenced, i.e., upstream, entities. In some embodiments, if a tag has been manually applied to the current entity, its value will be propagated to any referencing, i.e., downstream, entities. If the current entity has no manually applied tags, referenced (upstream) objects will be checked. In some embodiments, if there are any conflicts in the tags, the propagation will fail, and its failure logged. In some embodiments, the conflict will be propagated downstream, e.g., the downstream tag will have multiple values and will be logged as such for subsequent remediation. In some embodiments, if there are no conflicts in the tags, the upstream propagated tag will be passed to the referencing objects.

In some embodiments, the tag propagator 506 observes object privileges. In some embodiments, tag propagation is a privileged action. For example, if a user Alice sets a tag on a base table T owned by her, that tag would be propagated to a view V owned by Bob that references Alice's base table T. In some embodiments, however, a propagated tag is less privileged than a manually applied tag. In the above example, if the tag has a masking policy with which Bob doesn't agree, Bob could request Alice (as the Tag Administrator) to manually set a different value that would override the propagated value. In some embodiments, a consequence would be that any of Bob's objects that are dependent on view V would propagate this manual value.

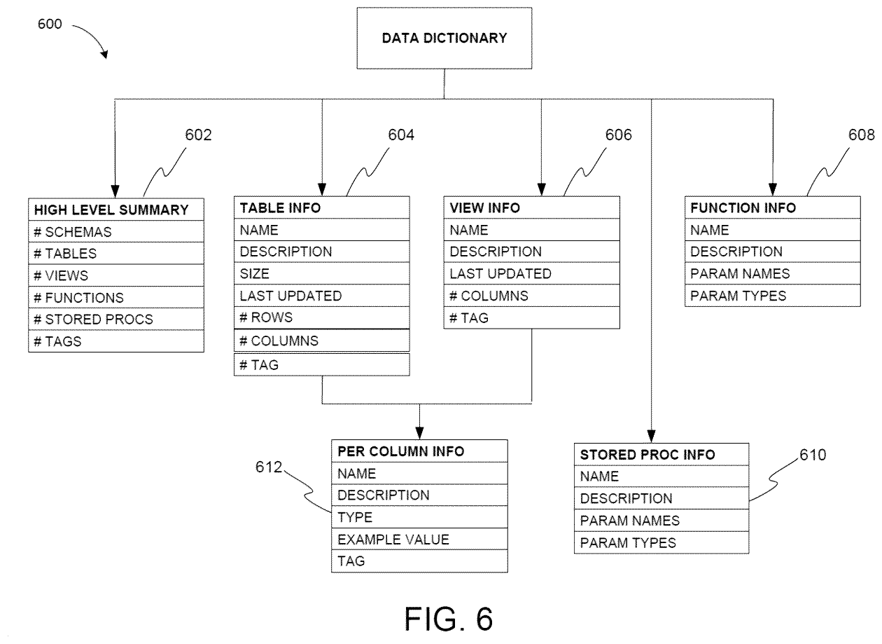

FIG. 6 is a block diagram illustrating an example data dictionary 600, in accordance with some embodiments of the present disclosure. As shown, the data dictionary 600 includes a high-level summary 602 of the shared data provided by the data listing 523, table information 604 describing the tables included in the shared data, view information 606 describing views in the shared data, function information 608 describing functions in the shared data and stored procedure information 610 describing stored procedures in the shared data. Per-column information 612 is also provided for each table and view in the shared data. Tag information is also disclosed in the high-level summary 602, table information 604, view information 606, and per-column information 612. As shown, each of the objects includes a set of data fields. For example, the high-level summary information 602 includes a number of schemas, tables, views, functions stored procedures, and tags in the shared data. The table information 604 includes a name, description, size, last update, number of rows number of columns, and tag for a table. The view information 606 includes a name, description, last update, number of columns, and tag for the view. The function information 608 and stored procedure information 610 both include the name, description, parameter names and parameter types of the function or stored procedure. Similarly, the per column information 612 includes a name, description, data value type, example value, and tag for each column included in a table or view. In some embodiments, when a SQL statement is parsed, the presence and value of tags associated with objects in the SQL statement are determined.

Compute service manager 112 may generate a data dictionary for each of the data listings 554 as shown in FIG. 5., e.g., as they are created and before any of them are retrieved. Data dictionaries provide the benefit of having information about the listing's data contents, such as table-names and per-column information, in a readily available and organized manner.

In some embodiments, tag propagation is a privileged action that happens by default when there is an object dependency. In some embodiments, propagation is triggered when the user/role exercises a privilege to operate on tags, e.g., a user applies a tag to an entity or changes a tag's PROPAGATE property. In some embodiments, there are two applicable privilege controls. First, an APPLY TAG privilege on the account allows a user to apply tags regardless of their privileges on the target entities. Alternatively, an APPLY TAG privilege on the tag and the OWNERSHIP privilege on the target object. In some embodiments, for this case, tag propagation occurs even if the user doesn't have an OWNERSHIP privilege over downstream objects. For example, if a user has access to the base table, without access to downstream views referencing the base table, any tags applied to the base table would be propagated to the views.

Automatic tag propagation can also incorporate rules to resolve ambiguity or conflict between propagated tags and directly applied tags. For cases in which a conflict cannot be resolved, propagation rules can provide a default value for the tag. Alternatively, such a conflict may result in propagation being skipped. While such an outcome may result in unprotected data, logging and auditing can monitor and support remediation of any propagation failures. Yet another option involves merging multiple values into a multi-value tag.

While tag propagation along object dependencies, e.g., CREATE VIEW FROM TABLE, have been discussed, a need also exists for propagating tags associated with data lineage/movement, e.g., a data manipulation language (DML) statement. For example:

$$INSERT INTO ‘ < object = \_name ’ > SELECT [ < c o l u m n s > ] FROM < table > ] ;$$

Both object-level and data lineage tag propagation can consider table-level and column-level tag propagation. Table level tag propagation involves tags associated tables, which are propagated when an object is referenced during object creation or when an object to another, e.g., “CREATE TABLE AS SELECT” or “CREATE VIEW.” If multiple tables are being used as data sources, then all the tags from all the source tables will be propagated. However, in some embodiments, if a table is only used to filter data and does not provide any columns to the target, its tags will not be propagated. By contrast, column-level tag propagation involves tags associated with columns, which will be propagated to derived columns, including projections, aggregations, and other transformations involving data movement from a source column to a target column.

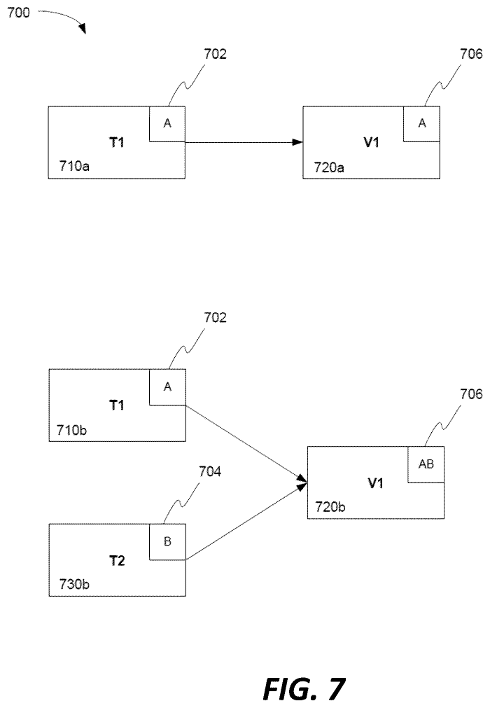

FIG. 7 is a flow diagram 700 illustrating automatic tag propagation, in accordance with some embodiments of the present disclosure. Table 710a includes a tag 702, whose value is set to a value “A.” View 720a is created that references table 710a. Through tag propagation, a tag 706 is associated with view 720a, having the value of tag 702 in the referenced table 710a.

In some embodiments, tag propagation resulting from a change to a tag begins with the construction of a directed acyclic graph (DAG) comprising objects related to the object undergoing the change. In some embodiments, the DAG represents all involved objects and their dependencies. In some embodiments, objects are traversed in topological order to ensure that every object is assessed after processing that object's upstream objects.

In some embodiments, a first use case comprises a change to a single object. In some embodiments, propagation starts from this root object, identifies and queries its direct downstream objects, then iteratively descends level by level to locate all the dependent objects. It then builds a DAG of the object tree.

In some embodiments, a second use case comprises building a DAG with multiple roots, all of which are objects associated with a tag having a PROPOGATE=TRUE value. In some embodiments, when there are a large number of entities involved in auto propagation, conducting a full scan of all active object dependencies per account is more efficient. Such an approach can construct a per-account complete DAG. The construction of such a DAG can involve a trade-off of memory utilization and time.

For correct propagation, an object computes its decision after determining that its upstream objects have calculated their decisions. “Topological Sort” is an efficient algorithm to traverse a DAG in an order such that a node is visited after their upstream nodes have been visited. While a correct object dependency DAG would not expect circular dependencies, such a condition can happen and needs to be checked. In some embodiments, special logic can detect circles in both DAG construction and traversal. In some embodiments, a visited node tracker can ensure that a node is only visited once. In some embodiments, a topological traversal test can be used to identify nodes having an upstream count larger than zero.

FIG. 7 further illustrates an example of conflict management, in accordance with some embodiments of the present disclosure. Table 710b includes a tag 702, whose value is set to a value “A.” View 720b is created referencing table 710b. Through tag propagation, tag 706 is associated with view 720b, having the value of tag 702 in the referenced table 710b. However, view 720b also references table 730b with a tag 704 having a value set to “B.” The values of tags 702 and 704 conflict. Rather than fail the tag propagation, tag 706 associated with view V720b is assigned both values, “A” and “B.” In some embodiments, this conflict is flagged for analysis. In some embodiments, such a conflict would prevent the creation of the view.

After traversing a DAG, a map can be constructed that specifies an action to be taken for each object and/or tag, which can include: creation of a new propagated tag; an update of a previously propagated tag; a removal of a previously propagated tag, due to unset and/or conflict; or no change.

In some embodiments, logging of propagation activity is provided. This logging can include 1) success events for which propagation succeeds. Users can query the history to determine what tags were propagated and when; 2) conflict events for which propagation encountered a conflict, resulting in wholly or partial failure to propagate. For such an event, facilitate investigation and resolution; and 3) failure events: likely due to unexpected exceptions that could require investigation by administrators.

Automatic tag propagation can apply to stages, tables, views, external views, materialized views, columns, and machine-learning (ML) objects. Stages are locations where data files are stored (staged) for loading and unloading data. They can be used to move data from one place to another, and the locations for the stages can be internal or external to a data exchange. Organizations can use a stage to move data from external data sources such as Amazon™ S3 buckets to internal tables or vice-versa. A stage can be used to manage data during the loading process. In some embodiments, organizations can employ stages to create temporary tables to store data before loading it into the main tables. This can allow organizations to ensure their data is getting appropriately loaded into a data exchange. Additionally, stages provide organizations with a secure environment to house their data. With encryption features readily available, organizations can enhance their data security and effectively guard against unauthorized access.

ML objects include application code and data for end-to-end machine language workflows, including components for model development and operations that support data preprocessing, feature engineering, and model training.

Each tag can be individually designated as to automatically propagate (or not). If automatic tag propagation is specified for a particular tag, propagate the tag if the associated object is referenced in a data definition language (DDL) statement, e.g., CREATE TABLE AS SELECT (CTAS) or CREATE VIEW, or if the associated object is referenced in a DML statement, e.g., “INSERT INTO Table1 SELECT Columns FROM Table2.”

Automatic tag propagation can result in tags being propagated from a source object to a destination object almost instantaneously, i.e., with minimal latency. A delay in propagating a tag can result in the data in the destination object being either unprotected or undiscoverable.

Automatic tag propagation can also provide an audit capability. An ability to identify both successful and failed tag propagation can be useful. The audit capability can indicate whether a tag was applied directly (manually) to an object or propagated.

Propagated tags can incorporate masking policies and enforce policies on target columns. If a source column has a masking policy attached, e.g., during a CTAS operation, masking policy can be applied to the source column, propagating the masked data into the target column. If the source column has policy tags, the policy tags can also be propagated to the target columns.

In some cases, the basis for the tag may be visible through a graphical user interface (GUI).

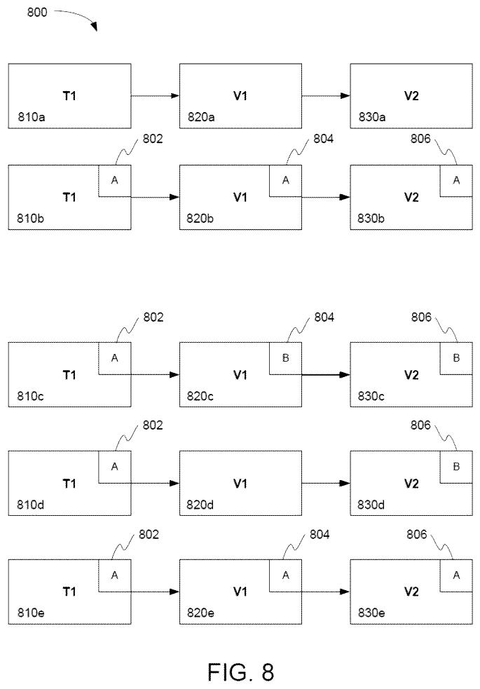

FIG. 8 is a flow diagram 800 illustrating automatic tag propagation, in accordance with some embodiments of the present disclosure. Flow diagram 800 begins with table 810a comprising tag 802. View 820a references table 810a. View 830a references view 820a. There are no tags in table 810a and thus nothing to be propagated to view 820a or view 830a. In table 810b, a tag 802 is created with a value of “A.” In some embodiments, this tag is created with:

$$CREATE TAG tag 1 COMMENT = ' A ' PROPAGATE = TRUE ;$$

As a consequence of tag propagation being enabled for table 810b, the tag is automatically propagated to tag 804 in view 820b and tag 806 in view 830b.

Table 810c is created with a tag 802 having a value of “A.” However, tag 804 on view 820c is updated with a value of “B.” Because view 830c references view 820c, this value “B” is propagated to tag 806 in view 830c, replacing the previous value of “A.”

The explicit tag created in view 820c is dropped in view 820d. Momentarily, in some embodiments, view 830d retains the tag value of “B” before tag propagation refreshes the tags. Post-refresh values of the objects can be observed in table 810e, view 820e, and view 830e. Views 820e and 830e inherit the tag values from table 810e and 820e respectively. In some embodiments, the deletion of tag 804 from view 820d and the refresh of views 820e and 830e occur within transactional boundaries such that a user would not see the inconsistency of table 810d, view 820d, and view 830d. Rather, dropping the manual tag 804 from view 820c would result in the tag values of 810e, 820e, and 830e.

In some embodiments, metrics recorded in support of automatic tag propagation include: Total count of tags with PROPAGATE=true, Per tag associated entities count, Total count of tag entity mappings with apply_method=PROPAGATE, CTAS counts and CTAS with tag propagation counts, On-event Continuous Propagation counts, On-event Continuous Propagation duration, On-event Continuous Propagation size, total propagation counts, total entities size in a directed acyclic graph (DAG) used to manage propagation, total dependencies size in the DAG, total conflict counts, total times tag propagation events write Access History, On-schedule Continuous Propagation duration, On-schedule Continuous Propagation size, total entities size in the per account full DAG, total dependencies size in the DAG, total involved entities size, per-entity max/avg tags, per-tag conflict counts, and total times Continuous Propagation writes Access History.

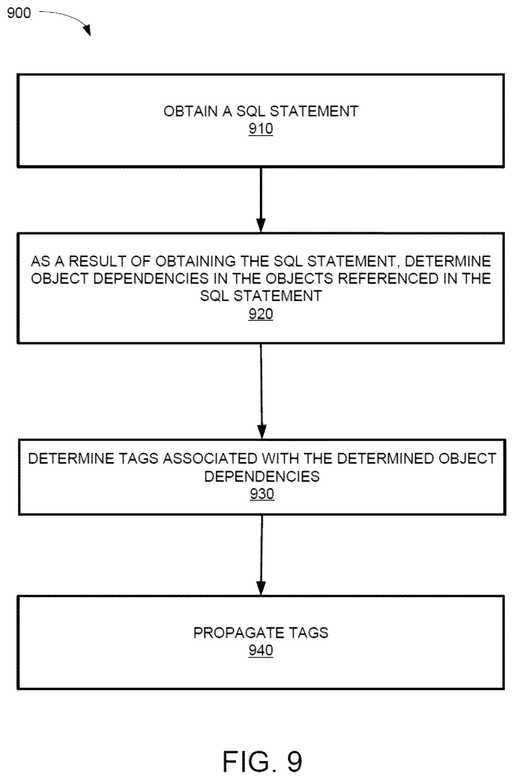

FIG. 9 is a flow diagram of a method 900 for providing automatic tag propagation in a data exchange, in accordance with some embodiments of the present disclosure. Method 900 may be performed by processing logic that may comprise hardware, e.g., circuitry, dedicated logic, programmable logic, a processor, a processing device, a central processing unit (CPU), or a system-on-chip (SoC), software, e.g., instructions running/executing on a processing device, firmware, e.g., microcode, or a combination thereof. In some embodiments, the method 900 may be performed by processing device 502, as illustrated in FIG. 5.

With reference to FIG. 9, method 900 illustrates example functions used by various embodiments. Although specific function blocks (“blocks”) are disclosed in method 900, such blocks are examples. That is, embodiments are well suited to performing various other blocks or variations of the blocks recited in method 900. It is appreciated that the blocks in method 900 may be performed in an order different than presented, and that not all of the blocks in method 900 may be performed.

At block 910, the method 900 may include obtaining a SQL statement. In some embodiments, the SQL statement may be a data definition language (DDL) statement. In some embodiments, the SQL statement may be a data manipulation language (DML) statement. In some embodiments, the SQL statement is obtained by tag propagator 506 as shown in FIG. 5. In some embodiments, the SQL statement is obtained as the result of a COMMIT statement issued by a user.

At block 920, the method 900 may include, as a result of obtaining the SQL statement, determining object dependencies in the objects referenced in the SQL statement. In some embodiments, the set of extracted terms are obtained by parsing the SQL statement. In some embodiments, the set of extracted terms is derived from one or more SQL statements exchanged with the data exchange. In some embodiments, the set of extracted terms include table names and column names associated with a data dictionary. In some embodiments, the SQL statement includes manually establishing a tag value.

At block 930, the method 900 may include determining tags associated with the determined object dependencies. In some embodiments, a directed acyclic graph is created to identify object dependencies.

At block 940, the method 900 may include propagating the tags. In some embodiments, propagating the tags includes identifying referencing objects with manually-established tags that override automatically propagated tags from upstream objects. In some embodiments, propagating the tags is done within database transactional boundaries.

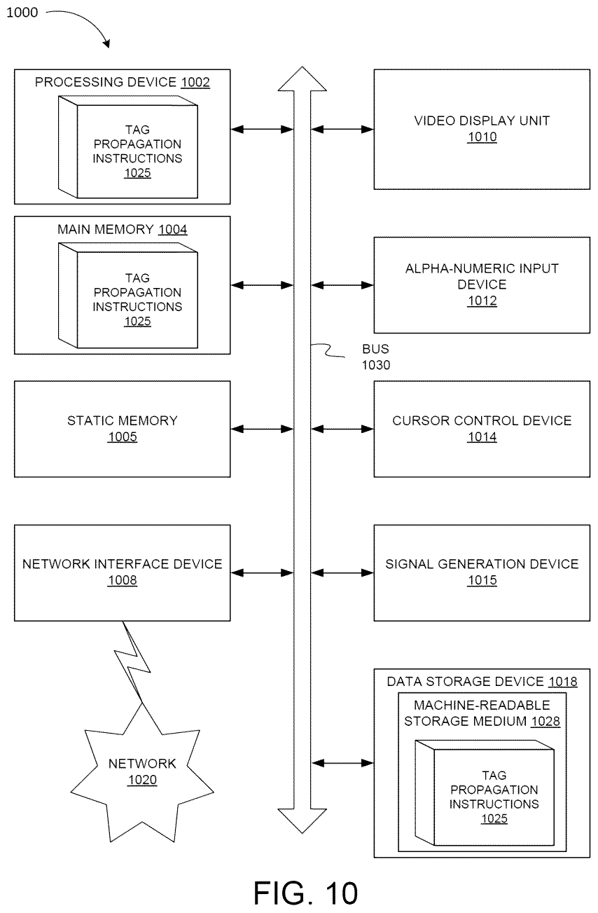

FIG. 10 is a block diagram of an example computing device that may perform one or more of the operations described herein, in accordance with some embodiments of the present disclosure. FIG. 10 illustrates an example computing device 1000 within which a set of instructions may propagate tags in a data exchange, in accordance with some embodiments of the present disclosure, as discussed in further detail herein.

In alternative embodiments, the machine may be connected, e.g., networked, to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1000 may be representative of a server.

The exemplary computer system 1000 includes a processing device 1002, a main memory 1004, e.g., read-only memory (ROM), flash memory, dynamic RAM (DRAM)), static memory 1005, e.g., flash memory or static RAM (SRAM), and a data storage device 1018, that communicate with each other via a bus 1030. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 1000 may further include a network interface device 1008 which may communicate with a network 1020. The computing device 1000 also may include a video display unit 1010, e.g., a liquid crystal display (LCD) or a cathode ray tube (CRT), an alphanumeric input device 1012, e.g., a keyboard, a cursor control device 1014, e.g., a mouse and an acoustic signal generation device 1015, e.g., a speaker. In one embodiment, video display unit 1010, alphanumeric input device 1012, and cursor control device 1014 may be combined into a single component or device, e.g., an LCD touch screen.

Processing device 1002 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 is configured to execute tag propagation instructions 1025, for performing the operations and steps discussed herein.

The data storage device 1018 may include a machine-readable storage medium 1028, on which is stored one or more sets of tag propagation instructions 1025, e.g., software embodying any one or more of the methodologies of functions described herein. The tag propagation instructions 1025 may also reside, completely or at least partially, within the main memory 1004 or within the processing device 1002 during execution thereof by the computer system 1000; the main memory 1004 and the processing device 1002 also constituting machine-readable storage media. The tag propagation instructions 1025 may further be transmitted or received over a network 1020 via the network interface device 1008.

The machine-readable storage medium 1028 may also be used to store instructions to perform the methods described herein. While the machine-readable storage medium 1028 is shown in an exemplary embodiment to be a single medium, the term “machine-readable storage medium” should be taken to include a single medium or multiple media, e.g., a centralized or distributed database, or associated caches and servers, that store the one or more sets of instructions. A machine-readable medium includes any mechanism for storing information in a form, e.g., software, processing application, readable by a machine, e.g., a computer. The machine-readable medium may include, but is not limited to, magnetic storage medium, e.g., a floppy diskette; an optical storage medium, e.g., a CD-ROM; magneto-optical storage medium; read-only memory (ROM); random-access memory (RAM); erasable programmable memory, e.g., EPROM or EEPROM; flash memory; or another type of medium suitable for storing electronic instructions.

Unless specifically stated otherwise, terms such as “recognizing,” “sending,” “receiving,” “selecting,” “extracting,” “installing,” “parsing,” “presenting,” or the like, refer to actions and processes performed or implemented by computing devices that manipulate and transform data represented as physical (electronic) quantities within the computing devices' registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure, e.g., circuitry, that performs the task or tasks during operation. As such, the unit/circuit/component can be said to be configured to perform the task, or configurable to perform the task, even when the specified unit/circuit/component is not currently operational, e.g., is not on. The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112(f) for that unit/circuit/component. Additionally, “configured to” or “configurable to” can include generic structure, e.g., generic circuitry, that is manipulated by software and/or firmware, e.g., an FPGA or a general-purpose processor executing software, to operate in manner that is capable of performing the task(s) at issue. “Configured to” may also include adapting a manufacturing process, e.g., a semiconductor fabrication facility, to fabricate devices, e.g., integrated circuits, that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources, e.g., networks, servers, storage, applications, and services, that can be rapidly provisioned (including via virtualization) and released with minimal management effort or service provider interaction and then scaled accordingly. A cloud model can be composed of various characteristics, e.g., on-demand self-service, broad network access, resource pooling, rapid elasticity, and measured service, service models, e.g., Software as a Service (“SaaS”), Platform as a Service (“PaaS”), and Infrastructure as a Service (“IaaS”), and deployment models, e.g., private cloud, community cloud, public cloud, and hybrid cloud.

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the embodiments of the present disclosure are not to be limited to the details given herein, but may be modified within the scope and equivalents of the appended claims.

1. A method, comprising:
obtaining a SQL statement;
as a result of obtaining the SQL statement, determining object dependencies in a first set of objects referenced in the SQL statement;
determining tags associated with the determined object dependencies; and
propagating, by a processing device, the tags to a second set of objects.

2. The method of claim 1, wherein the SQL statement comprises at least one of a creating statement or a modifying statement.

3. The method of claim 1, wherein propagating the tags comprises propagating a tag from a first object to a referencing object.

4. The method of claim 1, wherein propagating the tags comprises creating a tag in a first object and propagating the tag to a referencing object.

5. The method of claim 1, wherein propagating the tags comprises removing a tag from a first object and removing the tag from a referencing object.

6. The method of claim 1, wherein the tags are propagated within a transactional boundary.

7. The method of claim 1, wherein the tags are associated with at least one of:
a stage;
a table;
a view;
an external view;
a materialized view;
a column; or
a machine-learning object.

8. A system, comprising:
a memory; and
a processing device, operatively coupled to the memory, the processing device to:
obtain a SQL statement;
as a result of obtaining the SQL statement, determine object dependencies in a first set of objects referenced in the SQL statement;
determine tags associated with the determined object dependencies; and
propagate the tags to a second set of objects.

9. The system of claim 8, wherein the SQL statement comprises at least one of a creating statement or a modifying statement.

10. The system of claim 8, wherein to propagate the tags is further to propagate a tag from a first object to a referencing object.

11. The system of claim 8, wherein to propagate the tags is further to create a tag in a first object and propagate the tag to a referencing object.

12. The system of claim 8, wherein to propagate the tags is further to remove a tag from a first object and remove the tag from a referencing object.

13. The system of claim 8, wherein the tags are propagated within a transactional boundary.

14. The system of claim 8, wherein the tags are associated with at least one of:
a stage;
a table;
a view;
an external view;
a materialized view;
a column; or
a machine-learning object.

15. A non-transitory machine-readable medium storing instructions which, when executed by a processing device, cause the processing device to:
obtain a SQL statement;
as a result of obtaining the SQL statement, determine object dependencies in a first set of objects referenced in the SQL statement;
determine tags associated with the determined object dependencies; and
propagate, by the processing device, the tags to a second set of objects.

16. The non-transitory machine-readable medium of claim 15, wherein the SQL statement comprises at least one of a creating statement or a modifying statement.

17. The non-transitory machine-readable medium of claim 15, wherein to propagate the tags is further to propagate a tag from a first object to a referencing object.

18. The non-transitory machine-readable medium of claim 15, wherein to propagate the tags is further to create a tag in a first object and propagate the tag to a referencing object.

19. The non-transitory machine-readable medium of claim 15, wherein to propagate the tags is further to remove a tag from a first object and remove the tag from a referencing object.

20. The non-transitory machine-readable medium of claim 15, wherein the tags are propagated within a transactional boundary.
